(19) United States
(12) Patent Application Publication
(10) Pub. No.: US 2003/0202721 A1
(43) Pub. Date: Oct. 30, 2003

(54) Spindle motor having a fluid dynamic bearing system

(75) Inventor: Rikuro Obara, Nagano (JP)

Correspondence Address: SCHULTE ROTH & ZABEL LLP, ATTN: JOEL E. LUTZKER, 919 THIRD AVENUE, NEW YORK, NY, 10022, US

(73) Assignee: Minebea Co., Ltd., Kitasku-Gun (JP)

(21) Appl. No.: 10/426,437

(22) Filed: Apr. 30, 2003

(30) Foreign Application Priority Data
Apr. 30, 2002 (JP) 2002-127758

(51) Int. Cl. F16C 32/06; F16C 33/74

(52) U.S. Cl. 384/107; 384/132

(57) ABSTRACT

A spindle motor, a fluid dynamic bearing for the spindle motor, and a method of manufacturing the bearing wherein the bearing does not include a capillary seal fluid reservoir.

### REFERENCE TO RELATED APPLICATIONS

This application claims priority from Japanese Patent Application No. 2002-127758 filed on Apr. 30, 2002.

### FIELD OF THE INVENTION

The present invention relates to a fluid dynamic bearing. Specifically, it relates to a fluid dynamic bearing that does not incorporate a capillary seal fluid reservoir.

### BACKGROUND OF THE INVENTION

In recent years there has been a strong demand for smaller size, lighter weight, and higher memory capacity data recording devices such as magnetic disks and optical disks. This has led to a demand for technology to increase the rotational speed and stability of the spindle motors used to rotate such disks.

To meet this demand, manufacturers have begun utilizing fluid dynamic bearings, which support a rotating shaft or a rotating sleeve by generating a fluid dynamic pressure using a fluid, such as lubricating oil or air, instead of conventional ball bearings. An example of a prior art fluid dynamic bearing is shown in FIG. 5.

In FIG. 5, a fluid dynamic bearing is comprised of shaft 31, sleeve 32, gap 35, radial dynamic pressure generating grooves 33 and thrust dynamic pressure generating grooves 34. Gap 35 is filled with lubricating oil 12.

When shaft 31 rotates, the pressure gradients generated in lubricating oil 12 by radial dynamic pressure generating grooves 33 and thrust dynamic pressure generating grooves 34 enable shaft 31 to be suspended in sleeve 32 such that shaft 31 does not contact sleeve 32.

The volume of lubricating oil 12 varies due to changes in its temperature. Additionally, the volume of gap 35 varies due to changes in the temperature of shaft 31 or sleeve 32 and due to changes in the relative positions of shaft 31 and sleeve 32. Generally, the net effect of these volumetric changes is an increase in the level of lubricating oil 12 during rotation of the shaft as compared to when the shaft is stationary.

An elevation in the level of the lubricating oil 12 can cause leakage of the lubricating oil out of the bearing, which can result in the depletion of lubricating oil 12. Depletion of lubricating oil 12 can create problems such as insufficient fluid dynamic pressure, reduced lubrication function, and in some cases burning through contact between rotating shaft 31 and sleeve 32. Additionally, leakage of lubricating oil 12 can lead to the problem that the leaked lubricating oil can erase the magnetic disk recording.

In the prior art (as shown in FIG. 5), a capillary seal fluid reservoir 37 is used to prevent the problem of lubricating oil leakage. Capillary seal fluid reservoir 37 is formed by machining a tapered surface 36, which expands at an angle of inclination a, on the inner surface of sleeve 32 so that gap 35 gradually widens in the direction of the opening surface. Further, as shown in FIG. 5C, a configuration is also known whereby a lubricating oil collection point 38 is disposed on the inner surface of sleeve 32 below the tapered surface.

However, capillary seal fluid reservoirs have several disadvantages. For example, the gap between shaft 31 and sleeve 32 is wide at the opening of sleeve 32 making it is easier for dust and detritus to fall into the gap and mix with lubricating oil 12. Additionally, the radius of the sleeve inner surface increases near the opening of sleeve 32, so that lubricating oil 12 is effected by an increased centrifugal force (the tangential velocity of the oil adjacent to the sleeve inner surface increases as the radius of the sleeve inner surface increases) along the upper portion of the sleeve inner wall. This increased centrifugal force results in an elevated level of lubricating oil 12 at the outer diameter of capillary seal fluid reservoir 37 as compared to the inner diameter of capillary seal fluid reservoir 37.

Further, with respect to the sleeve inner surface, from a machining standpoint it can be quite difficult to machine a tapered surface with a diameter that expands on the outside. Given the current trend toward miniaturization of spindle motors, the process of manufacturing a tapered surface at a precise angle on the inner surface of the hub is particularly difficult, leading to problems such as increased manufacturing costs, etc.

The present invention seeks to resolve the above-described problems.

### SUMMARY OF THE INVENTION

In order to resolve the above problems, one aspect of the present invention is a fluid dynamic bearing that does not utilize a capillary seal fluid reservoir. A fluid dynamic bearing embodying this aspect of the invention includes a shaft, a sleeve, a gap between the shaft and the sleeve, lubricating fluid, and dynamic pressure generating grooves. The dynamic pressure generating grooves may be positioned either on the shaft or on the sleeve. A fluid dynamic bearing embodying this aspect of the invention does not include a capillary seal fluid reservoir.

Another aspect of the present invention is a process wherein the bearing properties and the lubricating oil properties are analyzed and an appropriate amount of lubricating oil is provided in the fluid dynamic bearing such that the minimum height of the fluid surface of the lubricating oil is at all times above the height of the dynamic pressure generating grooves and such that the maximum height of the fluid surface of the lubricating oil is at all times below the opening surface of the sleeve.

Additionally, a solid film of oil repellent may be formed along the opening edge of the top end surface of the sleeve, and a solid film of oil repellent may be formed on the outer peripheral surface of the shaft above the position of the top end of the above sleeve.

Further, in order to prevent contact between the shaft and the sleeve at a point in the bearing above the height of the fluid surface of the lubricating oil, the size of the gap between the shaft and the sleeve may be slightly enlarged above the minimum height of the fluid surface of the lubricating oil. Such enlargement can be accomplished by either slightly increasing the inner diameter of the upper portion of the sleeve or by slightly decreasing the outer diameter of the upper portion of the shaft. However, such enlargement of the gap is not sufficient to constitute a fluid reservoir.

These and other objects, features, and advantages of the present invention will become more apparent in light of the following detailed description and accompanying drawings.

### BRIEF DESCRIPTION OF THE DRAWINGS

The present invention will be more easily understood with reference to the following drawings.

FIG. 1A is an overall constitution of a spindle motor incorporating the first embodiment of the present invention.

FIG. 1B is a partial constitution of a spindle motor incorporating the first embodiment of the present invention showing the fluid dynamic bearing and the stator.

FIG. 2A shows an exploded perspective view of a fluid dynamic pressure bearing embodying the present invention as viewed from diagonally above.

FIG. 2B shows an exploded perspective view of a fluid dynamic pressure bearing embodying the present invention as viewed from diagonally below.

FIG. 3A is a diagram showing the main portions of the first embodiment of the present invention.

FIG. 3B is a diagram showing the static fluid surface of the lubricating oil.

FIG. 3C is a diagram showing the dynamic fluid surface of the lubricating oil.

FIG. 4A depicts the main portions of the second embodiment of the present invention in a cold non-rotating state.

FIG. 4B depicts the main portions of the second embodiment of the present invention in a hot rotating state.

FIG. 4C depicts the main portions of the third embodiment of the present invention in a cold non-rotating state.

FIG. 4D depicts the main portions of the third embodiment of the present invention in a hot rotating state.

FIG. 5A is a diagram showing a prior art fluid dynamic bearing.

FIG. 5B is a diagram showing a prior art fluid dynamic bearing.

FIG. 5C is a diagram showing a prior art fluid dynamic bearing.

FIG. 6 is a diagram showing the main portions of an additional embodiment of the present invention.

### DETAILED DESCRIPTION OF THE PREFERRED EMBODIMENT

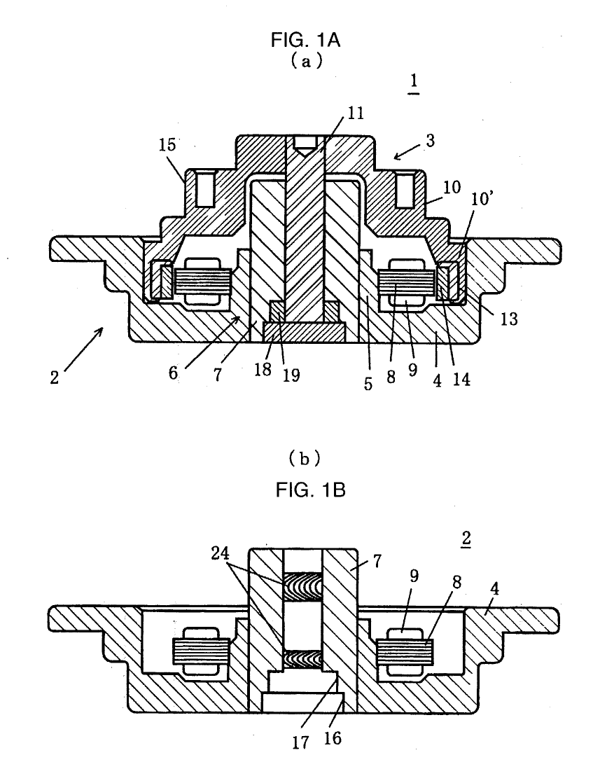

FIGS. 1A and 1B depict the overall constitution of a spindle motor incorporating the first embodiment of the present invention. The spindle motor 1 is used as a motor for a data storage device such as a magnetic disk or an optical disk. Overall, it is comprised of a stator assembly 2 and a rotor assembly 3.

The stator assembly 2 is comprised of frame 4, sleeve 7, windings 8, core 9, and counter plate 18. Frame 4 can be affixed to the main portion of the data storage device, which is not shown. Windings 8 and core 9 are affixed to frame 4 and they form an electro magnet. Sleeve 7 is affixed to frame 4 and counter plate 18 is inserted into first sleeve inner surface 16 and affixed to sleeve 7.

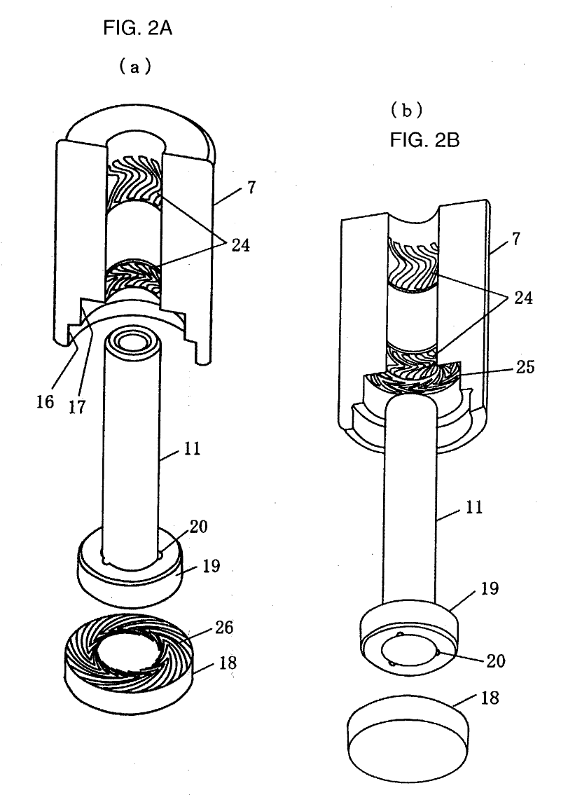

Rotor assembly 3 is comprised of hub 10, shaft 11, yoke 13, magnet 14, and thrust washer 19. Thrust washer 19 is affixed to shaft 11 and openings 20 are provided between thrust washer 19 and shaft 11 (see FIG. 2). Additionally, hub 10 is affixed to the top end of shaft 11, yoke 13 is affixed to the lower portion of hub 10, and magnet 14 is affixed to yoke 13. A data storage device rotating disk, not shown, (eg. a magnetic disk) is fit onto the top edge portion 15 of hub 10.

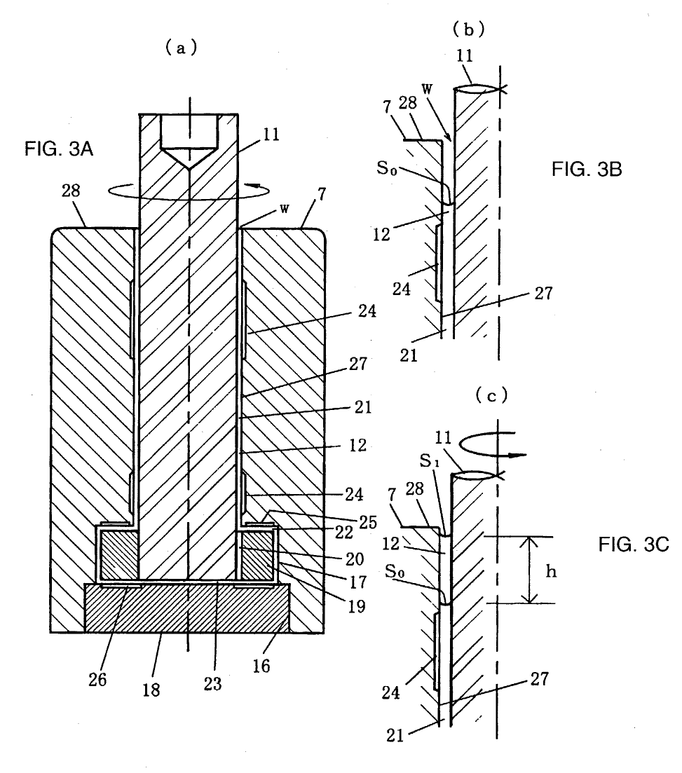

As shown in FIGS. 2 and 3, shaft 11 and thrust washer 19 are inserted into the opening formed by sleeve 7 and counter plate 18. First gap 21 is provided between shaft 11 and first inner sleeve surface 27, second gap 22 is provided between thrust washer 19 and second inner sleeve surface 17, and third gap 23 is provided between thrust washer 19/shaft 11 and counter plate 18. Additionally, two sets of dynamic pressure grooves 24 are formed on first inner sleeve surface 27(these grooves could also be formed on the opposing surface of shat 11), first thrust dynamic pressure generating grooves 25 are formed on the upper surface of thrust washer 19(these grooves could also be formed on the opposing surface of sleeve 7), and second thrust dynamic pressure generating grooves 26 are formed on the upper surface of counter plate 18(these grooves could also be formed on the opposing lower surface of thrust washer 19).

Lubricating oil 12 is provided within the space between sleeve 7 and shaft 11. Said space is comprised of first gap 21, second gap 22, and third gap 23. The level of lubricating oil 12 is always above the top of the upper set of dynamic pressure generating grooves 24 and below the top of sleeve 7.

When the spindle motor 1 is turned on, windings 8 and core 9 generate a magnetic field that interacts with magnets 14 to generate a force. Said force is applied to hub 10 through yoke 14 causing the rotor 3, including shaft 11, and thrust washer 19, to rotate.

Fluid dynamic pressure bearing 6 is comprised of sleeve 7, shaft 11, lubricating oil 12, thrust washer 19, counter plate 18, first gap 21, second gap 22, third gap 23, dynamic pressure generating grooves 24, first thrust dynamic pressure generating grooves 25, and second thrust dynamic pressure generating grooves 26.

When manufacturing bearing 6, it may be necessary to remove a burr, which may form on the corner areas where the inner surface of sleeve 7 and the top edge surface of sleeve 7 cross. However, the resulting tiny deburred surface is not a capillary seal fluid reservoir

During the rotation of shaft 11, dynamic pressure generating grooves 24 interact with lubricating oil 12 to generate pressure gradients in first gap 21 that resist horizontal motion of the shaft and that prevent or minimize contact between the shaft and the first inner surface of sleeve 27; first thrust dynamic pressure generating grooves 25 interact with lubricating oil 12 to generate pressure gradients in second gap 22 that apply a downward force on the shaft; second thrust dynamic pressure generating grooves 26 interact with lubricating oil 12 to generate pressure gradients in third gap 23 that apply an upward force on the shaft. Accordingly, the shaft 11 and thrust washer 19 float stably within the opening formed by sleeve 7 and counter plate 18.

It should be noted that bearing 6, as shown in FIG. 3, can be manufactured with only one set of dynamic pressure generating groves 24. Additionally, thrust washer 19 and counter plate 18 are not necessary components of bearing 6, since the sleeve can be manufactured to enclose the bottom of the shaft and since the thrust dynamic pressure generating grooves can be placed on the bottom of the shaft or on the opposing surface of the sleeve. Further, dynamic pressure generating groves 24 can be placed on shaft 11 instead of sleeve 7 and bearing 6 can be manufactured such that shaft 11 is stationary and sleeve 7 rotates.

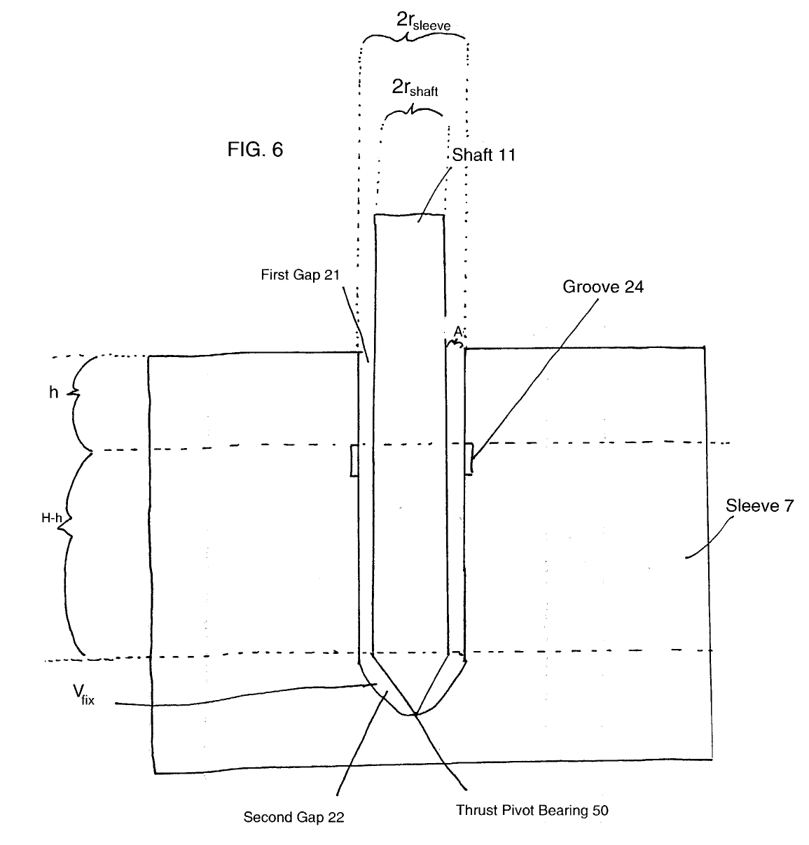

FIG. 6 shows another bearing embodying the present invention. The bearing shown in FIG. 6 includes shaft 11, sleeve 7, dynamic pressure generating groves 24, and thrust pivot bearing 50.

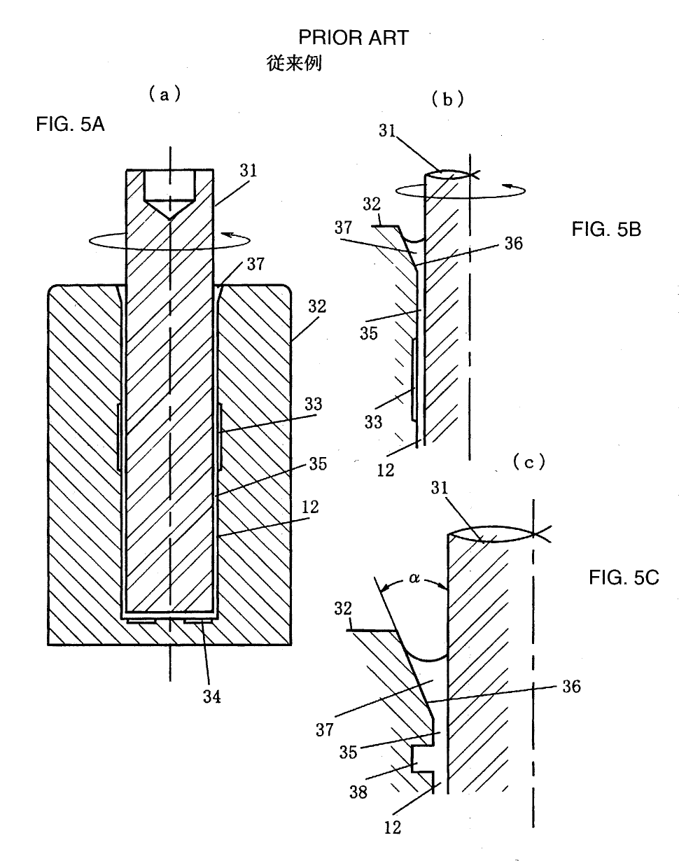

Fluid dynamic pressure bearing 6, as shown if FIGS. 1, 2, and 3, does not include a capillary seal fluid reservoir. Capillary seal fluid reservoirs are used in the prior art fluid dynamic pressure bearings, such as the bearings shown if FIG. 5, to prevent lubricating oil leakage and to prevent the level of the lubricating oil from falling below the height of the dynamic pressure generating grooves. In the prior art bearings shown if FIG. 5, capillary seal fluid reservoir 37 is formed by machining a tapered surface 36, which expands at an angle of inclination α, on the inner surface of sleeve 32 so that gap 35 gradually widens in the direction of the opening surface of sleeve 32.

In accordance with an aspect of the present invention, fluid dynamic pressure bearing 6 is manufactured, without a capillary seal fluid reservoir, such that the minimum level of the fluid surface of lubricating oil 12 is at a position above the highest level of dynamic pressure generating grooves 24 and such that the maximum level of the fluid surface of lubricating oil 12 is at a position below the opening surface of first gap 21. This aspect of the invention is depicted FIGS. 3B and 3C. When shaft 11 is at rest and lubricating oil 12 is at room temperature (approximately 25° C.), the fluid surface (referred to as the “static fluid surface”) of lubricating oil 12 is positioned above dynamic pressure generating grooves 24 at level So. When shaft 11 rotates, the lubricating oil heats up and the fluid surface of lubricating oil 12 rises by a height h to level S₁ (referred to as the “dynamic fluid surface”). Accordingly, fluid dynamic bearing 6 is able to prevent lubricating oil leakage and it is able to prevent the level of the lubricating oil from falling below the height of the dynamic pressure generating grooves without utilizing a capillary seal fluid reservoir.

In order to manufacture a bearing in accordance with this aspect of the invention, the bearing should be designed such that the above described conditions for the static fluid surface level So and the dynamic fluid surface level S1 are satisfied regardless of the spindle motor usage environment or usage attitude (spindle motor inclination during use). In other words, the design is such that the above conditions are met in all allowable operating conditions, including operation at extreme temperatures and angles. However, it may be allowable in extreme conditions for the static fluid surface level So to dip slightly below the top of the upper set of dynamic pressure generating grooves 24.

For example, even if the temperature of lubricating oil 12 falls to the lowest usable temperature for the equipment in which the spindle motor is used (the minimum design operating temperature), the bearings must be designed such that the level of the static fluid surface of lubricating oil 12 will not go below the top of dynamic pressure generating grooves 24. In general, spindle motors are designed to operate over a range of approximately 0-100° C., but, there are instances in which the spindle motor must be designed to operate in more extreme temperatures, for instance certain notebook computers require spindle motors that operate at −20° C., and some automobile equipment requires spindle motors that operate at −30° C.

The volumetric change in lubricating oil 12 due to changes in temperature is calculated by the following Equations 1 and 2.

Va/Nb=1+α·ΔT (Equation 1),

and

Vexp=Vb(α·ΔT) (Equation 2)

Where,

Va: lubricating oil volume after the temperature change

Vb: lubricating oil volume before the temperature change

Vexp=the expansion volume

α: coefficient of thermal expansion

ΔT: change in lubricating oil temperature (° C.)

In general, the coefficient of thermal expansion α(t) is a function of the temperature and it is not constant over a given temperature range. However, for the fluids generally used as lubricating oil in fluid dynamic bearings and for the applicable temperature range, α(t) can normally be approximated by a constant α, where α is approximately equal to the integral of α(t) from the minimum temperature to the maximum temperature divided by the maximum temperature minus the minimum temperature.

$$∝ = ( {\int }_{0}^{1} ∝ ( T ) ⅆ t ) / ( {t}_{1} - {t}_{0} ) \qquad ( Equation 3 )$$

The manufacturers of lubricating oil can generally provide an appropriate value for α. For α=0.078×10⁻³/° C., which is a typical a for a lubricating oil, and for a temperature change of 100° C., which is the approximate temperature change from steady state non-rotating shaft to steady state rotating-shaft, the expansion of the lubricating oil is provided by the following calculation:

Va/Vb=1+0.078×10⁻³/° C.×100=1.0078

or

Vexp=Vb(0.0078).

Thus, If the volume of the provided lubricating oil is 10 cc, the volume of expansion will be about 0.078 cc. In other words, when the spindle motor rotates, the lubricating oil expands about 0.78%.

Although the primary factor affecting the level of lubricating oil 12 is lubricating oil 12's temperature, the level of the lubricating oil 12 is also affected by additional factors, including volumetric changes in first gap 21, second gap 22, or third gap 23 due to temperature changes in the bearing components (i.e. sleeve 7, shaft 11, or counter plate 18); internal movement of the bearing components; internal movement of the lubricating oil due to pump effects or dynamic pressure effects during rotation or at start up; and centrifugal force effects on the lubricating oil.

Centrifugal force operates on the lubricating oil provided in first gap 21 between sleeve 7 and rotating shaft 11 when the spindle motor rotates, and the lubricating oil surface (meniscus) rises somewhat along the inner surface of sleeve 7. The extent of this rise differs depending on the dimension of the gap between sleeve 7 and rotating shaft 11, the density and viscosity of the lubricating oil, etc. The amount of the lubricating oil rise caused by centrifugal force is determined by design or experimentation, taking these various conditions into account.

The overall effect of these additional factors is dependant upon the bearing design parameters, such as the dimensions and composition of the shaft 11, the dimensions and composition of the sleeve 7, the type of lubricating oil 12, etc. Accordingly, the overall effect of the additional factors can be controlled by manipulating the bearing design parameters. However, manipulating the bearing design parameters can affect the operational characteristics of the bearing, such as its stiffness, its energy consumption, and its durability and such manipulation can also affect the cost of the bearing.

The number of sets of dynamic pressure generating grooves 24 and the maximum height of the dynamic pressure generating grooves 24 are also important design parameters. Not only do these parameters directly affect the bearing performance characteristics, but the allowable lubricating oil 12 expansion volume is directly proportional to the difference between the maximum height of the dynamic pressure generating grooves 24 and the top of sleeve 7.

According to an aspect of the present invention, a fluid dynamic bearing 6 not having a capillary seal, as shown in FIGS. 1-3, is designed and manufactured such that the maximum increase in the level of lubricating oil 12 is less than the difference in height between the top of the upper set of dynamic pressure generating grooves 24 and the top of sleeve 7.

A method in accordance with the following invention is to position the upper set of dynamic pressure generating grooves 24 (either one or two sets of dynamic pressure generating grooves 24 may be used) such that the maximum expansion volume of the lubricating oil 12 is less than the volume contained in first gap 21 between the top of the upper set of dynamic pressure generating grooves 24 and the top of sleeve 7. This can be accomplished by positioning the upper set of dynamic pressure generating grooves 24 such that the volume contained in first gap 21 from the top of the upper set of dynamic pressure generating grooves 24 to the top of sleeve 7 is greater than the expansion volume of lubricating oil 12, where the expansion volume of lubricating oil 12 is measured using the Equation 2.

Vexp=Vb(α·ΔT) (Equation 2)

Vb is set equal to the total oil containing volume in the oil containing spaces below the top of the upper set of dynamic pressure generating grooves 24 (e.g. First gap 21 below the top of the upper set of dynamic pressure generating grooves 24, second gap 22, third gap 23, and thrust washer through holes 20), a is the thermal expansion coefficient for the applicable lubricating oil, and ΔT is the difference between the maximum possible temperature for the lubricating oil during motor operation and the minimum operating temperature for the motor.

For a bearing where all the parameters are known except for the height of the upper set of dynamic pressure generating grooves 24, the height of the upper set of dynamic generating grooves 24 can be determined by rewriting Equation 2 in the following manner.

A(h)=(A(H−h)+V_{fix})(α·ΔT) (Equation 3)

Where,

A=Πr²ₛₗₑᵥₑ−Πr²_{shaft};

h=the distance from the top of the upper set of dynamic pressure generating grooves 24 to the top of sleeve 7;

H=the length of first gap 21 (the distance from the top of sleeve 7 to the top of second gap 22);

V_{fix}=the oil containing volume below first gap 21 (the volume of second gap 22 plus the volume of third gap 23 plus the volume of thrust washer through holes 20);

α=the coefficient of thermal expansion for the lubricating oil;

ΔT=the design maximum operating temperature for the lubricating oil minus the design minimum operating temperature for the lubricating oil.

Equation 3 can be rewritten as

h=(AH+V_{fix})(α·ΔT)/(A+A(α·ΔT)) (Equation 4)

Since all of the values except for h are known, h can be solved for. The resulting value for h is the minimum distance below the top of sleeve 7 that the top of the upper set of dynamic pressure generating grooves 24 should be set.

Equation 4 does not take into account the additional factors, other than temperature, that affect the level of lubricating oil 12. However, through experimentation and engineering analysis, the effect of the additional factors (Δh) can be determined and the value of h can be appropriately modified by Δh to determine a new value h1=h+Δh. The upper set of dynamic pressure generating grooves 24 should then be positioned such that the maximum height of any groove is at least a distance h1 below the top of sleeve 7.

Another method in accordance with the following invention is to fill bearing 6 with a volume of lubricating oil such that the level of lubricating oil 12 is always at least as high as the top of dynamic pressure generating grooves 24 and such that the level of lubricating oil 12 never reaches the top of sleeve 7. For lubricating oil at a given temperature, the volume of lubricating oil to be added must be greater than a volume V₁ and it must be less than a volume V₂, where V₁ and V₂ are given by the following Equations 5 and 6.

V₁=A(H−h)+V_{fix}+(A(H−h)+V_{fix})(α·ΔT₁) (Equation 5),

and

V₂=A(H)+V_{fix}+(A(H)+V_{fix})(α·ΔT₂) (Equation 6)

Where,

A=Πr²ₛₗₑᵥₑ−Πr²_{shaft};

h=the distance from the top of the upper set of dynamic pressure generating grooves 24 to the top of sleeve 7;

H=the length of first gap 21 (the distance from the top of sleeve 7 to the top of second gap 22);

V_{fix} =the oil containing volume below first gap 21 (the volume of second gap 22 plus the volume of third gap 23 plus the volume of thrust washer through holes 20);

α=the coefficient of thermal expansion for the lubricating oil;

ΔT₁=the temperature for the lubricating oil being added minus the minimum operating temperature for the motor;

ΔT₂=the temperature for the lubricating oil being added minus the maximum possible temperature for the lubricating oil during motor operation.

The above equations do not take into account the additional factors, other than temperature, that affect the level of lubricating oil 12. However, through experimentation and engineering analysis, the effect of the additional factors can be determined and the values of V₁ and V₂ can be appropriately modified. If the various dimensions correspond to a cold non-operating condition, then only the value of V₂ need be modified to take into account the additional factors. The volume of lubricating oil provided in the bearing should be between the modified values of V₁ and V₂.

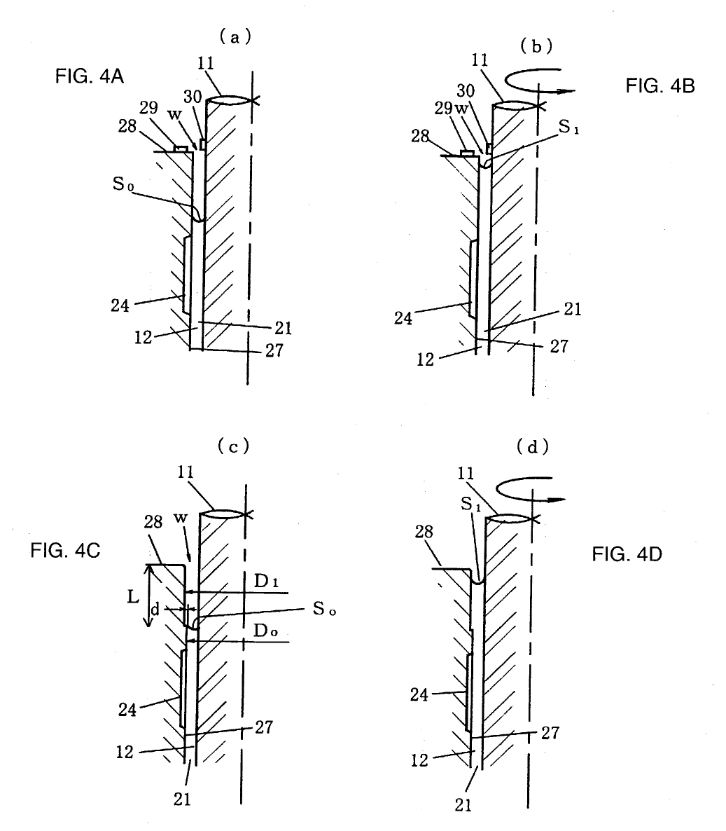

FIGS. 4A, and B depict the second embodiment of the present invention. FIG. 4A shows the bearing with shaft 11 at rest; and FIG. 4B shows the bearing with shaft 11 rotating. The second embodiment is almost identical to the first embodiment (shown in FIGS. 1, 2, and 3), except that the second embodiment has the additional features that are discussed below and which are shown in FIGS. 4A, and B.

As described above, the first embodiment functions to fully contain lubricating oil 12 by securing a space corresponding to the lubricating oil 12 expansion volume in the first gap 21 below the opening surface W. The second embodiment is constructed in the same manner as the first embodiment, except that a first oil repellent solid film 29 is formed in a position following the opening edge of sleeve 7 on sleeve 7's top edge surface 28, and a second oil repellent solid film 30 is formed on the outer surface of rotating shaft 11, just above the top end of sleeve 7. First oil repellent solid film 29 and second oil repellent solid film 30 are positioned on the bearing in order to further improve the lubricating oil containment function.

In the unlikely event that the level of the provided lubricating oil rises above the top edge of sleeve 7, lubricating oil 12 will be repelled by the oil repellency of first oil repellent solid film 29 and second oil repellent solid film 30 and leakage of lubricating oil 12 will be prevented.

FIGS. 4C and D show the third embodiment of the present invention. FIG. 4C shows the bearing with shaft 11 at rest; and FIG. 4D shows the bearing with shaft 11 rotating. The third embodiment is almost identical to the first embodiment (shown in FIGS. 1, 2, and 3), except that the third embodiment has the additional features that are discussed below and which are shown in FIGS. 4C, and D.

In the first embodiment of the present invention, as shown in FIG. 3D, the portion of first gap 21 between the static fluid surface So and the dynamic fluid surface S₁ does not contain lubricating oil 12 when lubricating oil 12 is cold, such as when shaft has been at rest for an extended period of time. Accordingly, when spindle motor 1 (shown in FIG. 1) starts up, shaft 11 may rotate for a very short time with no lubricating oil in the portion of first gap 21 between the static fluid surface S₀ and the dynamic fluid surface S₁. During this very short period of time, rotating shaft 11 may contact sleeve 7 at a point where there is no lubricating oil.

Such contact will not cause a significant problem, if the distance between S₀ and S₁ is small with respect to the overall length of the bearing surface. However, when the distance between S₀ and S₁ is not small significant problems may occur (for example, shaft 11 could become fused to sleeve 7).

In order to eliminate the problems caused by non-lubricated contact between shaft 11 and sleeve 7 at the startup of spindle motor 1, the diameter D1 of a portion of sleeve 7 that is positioned above the level of the static fluid surface So is made larger by a tiny dimension 2d than the diameter Do, which is the inside diameter of the remainder of sleeve 7. This slight enlargement of the inner diameter of sleeve 7 does not constitute a capillary seal fluid reservoir, since the enlarged area is much smaller and differently constituted than a capillary seal fluid reservoir. Additionally, the slightly enlarged portion of sleeve 7 may begin at a height slightly higher or slightly lower than the level of static fluid surface S₀.

The drawings and descriptions of the preferred embodiments are made by way of example rather than to limit the scope of the inventions, and they are intended to cover, within the spirit and scope of the inventions, all such changes and modifications stated above.

What is claimed is:

1. A fluid dynamic bearing comprising:
a shaft;
a sleeve;
a space between said shaft and said sleeve; and
a liquid contained in the space between said shaft and said sleeve;
wherein at least one of said shaft or said sleeve has a set of dynamic pressure generating grooves formed thereon; and
wherein said bearing does not include a capillary seal fluid reservoir.

2. The fluid dynamic bearing of claim 1 wherein:
said bearing does not include a fluid reservoir.

3. The fluid dynamic bearing of claim 1 further comprising:
a thrust washer; and
a counter plate;
wherein at least one of said thrust washer or said counter plate has a set of dynamic pressure generating grooves formed thereon.

4. The fluid dynamic bearing of claim 1 further comprising:
a pivot thrust bearing.

5. The fluid dynamic bearing of claim 1 further comprising:
an oil repellent solid film positioned on the top surface of the sleeve near said shaft.

6. The fluid dynamic bearing of claim 1 further comprising:
an oil repellent solid film positioned on the shaft slightly above the top of the sleeve.

7. The fluid dynamic bearing of claim 1 wherein:
the sleeve has a slightly increased inner diameter from some point above the dynamic pressure generating grooves to the top of the sleeve.

8. The fluid dynamic bearing of claim 1 wherein:
the shaft has a slightly decreased diameter from some point above the dynamic pressure generating grooves to at least the top of the sleeve.

9. A fluid dynamic bearing comprising:
a shaft;
a sleeve;
a space between said shaft and said sleeve; and
a liquid contained in the space between said shaft and said sleeve;
wherein at least one of said shaft or said sleeve has a set of dynamic pressure generating grooves formed thereon; and
wherein the size of the space is substantially constant, from a volume containing perspective, from the top of the sleeve to a point below the top of the dynamic pressure generating grooves.

10. The fluid dynamic bearing of claim 9 wherein there is a slight increase in the size of the space at some point above the dynamic pressure generating grooves.

11. A spindle motor comprising:
a stator; and
a rotor;
wherein
said stator comprises
a frame;
a sleeve; and
an electromagnet;
said rotor comprises
a hub;
a shaft;
and a magnet;
a space exists between said shaft and said sleeve;
a liquid is contained in the space between said shaft and said sleeve;
at least one of said shaft or said sleeve has a set of dynamic pressure generating grooves formed thereon; and
said spindle motor does not include a capillary seal fluid reservoir.

12. The spindle motor of claim 11 wherein:
said spindle motor does not include a fluid reservoir.

13. The spindle motor of claim 11 wherein:
said rotor further comprises a thrust washer;
said stator further comprises a counter plate; and
at least one of said thrust washer or said counter plate has a set of dynamic pressure generating grooves formed thereon.

14. The spindle motor of claim 11 further comprising:
a pivot thrust bearing.

15. The spindle motor of claim 14 further comprising a magnetic shield to resist upward motion of the shaft.

16. A spindle motor comprising:
a stator; and
a rotor;
wherein
said stator comprises
a frame;
a sleeve; and
an electromagnet;
said rotor comprises
a hub;
a shaft;
and a magnet;
a space exists between said shaft and said sleeve;
a liquid is contained in the space between said shaft and said sleeve;
at least one of said shaft or said sleeve has a set of dynamic pressure generating grooves formed thereon; and
the size of said space is substantially constant, from a volume containing perspective, from the top of the sleeve to a point below the top of the dynamic pressure generating grooves.

17. The spindle motor of claim 16 wherein
there is a slight increase in the size of the space at some point above the dynamic pressure generating grooves.

18. A method for manufacturing a fluid dynamic bearing that does not have a capillary seal fluid reservoir, wherein the bearing includes a shaft, a sleeve, a space between said shaft and said sleeve, and a liquid contained in the space between said shaft and said sleeve, comprising the step of:
forming a plurality of dynamic pressure generating grooves on at least one of said shaft or said sleeve such that the volume contained in said space between the top of the uppermost groove of said plurality of grooves and the top of said sleeve is less than the expansion volume of said liquid.

19. A method for manufacturing a fluid dynamic bearing, wherein the bearing includes a shaft, a sleeve, a plurality of dynamic pressure generating grooves, a space between said shaft and said sleeve that is substantially constant in size from the top of the sleeve to a point below the top of the dynamic pressure generating grooves, and a liquid contained in the space between said shaft and said sleeve, comprising the steps of:
calculating a distance h according to the following equation:
h=(AH+V_{fix})(α·ΔT)/(A+A(α·ΔT))
Wherein,
A=Πr²ₛₗₑᵥₑ−Πr²_{shaft};
rₛₗₑᵥₑ=the inner radius of the sleeve,
r_{shaft}=the radius of the shaft,
H=the length of said space from the top of the sleeve to the point at which the quantity rₛₗₑᵥₑ−r_{shaft} is not substantially constant,
V_{fix}=the oil containing volume below the point at which the quantity rₛₗₑᵥₑ−r_{shaft} is not substantially constant,
α=the coefficient of thermal expansion for the liquid,
ΔT=the design maximum operating temperature of the liquid minus the design minimum operating temperature of the liquid; and
placing the plurality of dynamic pressure generating grooves on at least one of said shaft or said sleeve such that the top of each said groove is at least a distance h below the top of the sleeve.

20. The method of claim 19 further comprising the steps of:
quantifying any additional effects, other than the temperature of the liquid, on the change in liquid level from a cold non-operating condition to a hot operating condition;
adjusting the distance h by the quantified amount.

21. A method for manufacturing a fluid dynamic bearing that does not have a capillary seal fluid reservoir, wherein the bearing includes a shaft, a sleeve, a space between said shaft and said sleeve, and a plurality of dynamic pressure generating grooves, comprising the step of:
filling the space between said shaft and said sleeve with an amount of a liquid such that each groove of said plurality of grooves is always covered by said liquid and such that the level of said liquid never rises above said sleeve.

22. A method for manufacturing a fluid dynamic bearing, wherein the bearing includes a shaft, a sleeve, a plurality of dynamic pressure generating grooves, a space between said shaft and said sleeve that is substantially constant in size from the top of the sleeve to a point below the top of the dynamic pressure generating grooves, and a liquid contained in the space between said shaft and said sleeve, comprising the steps of:
calculating volumes V₁ and V₂ according to the following equations:
V₁=A(H−h)+V_{fix}+(A(H−h)+V_{fix})(α·ΔT₁),
and
V₂=A(H)+V_{fix}+(A(H)+V_{fix})(α·ΔT₂)
Wherein,
A=Πr²ₛₗₑᵥₑ−Πr²_{shaft};
rₛₗₑᵥₑ=the inner radius of the sleeve,
r_{shaft}=the radius of the shaft,
H=the length of said space from the top of the sleeve to the point at which the quantity rₛₗₑᵥₑ−r_{shaft} is not substantially constant,
V_{fix}=the oil containing volume below the point at which the quantity rₛₗₑᵥₑ−r_{shaft} is not substantially constant,
α=the coefficient of thermal expansion for the liquid,
ΔT₁=the temperature for the lubricating oil being added minus the minimum design operating temperature of the liquid,
ΔT₂=the temperature for the lubricating oil being added minus the maximum design operating temperature of the liquid;
filling the bearing with a volume of the liquid greater than the volume V₁ and less than the volume V₂.

23. A method according to claim 22 further comprising the steps of:
quantifying any additional effects, other than the temperature of the liquid, on the change in liquid level from a cold non-operating condition to a hot operating condition;
adjusting the volume V₂ by the quantified amount.
